(19) United States
(12) Patent Application Publication
(10) Pub. No.: US 2020/0316842 A1
(43) Pub. Date: Oct. 8, 2020

(54) STRETCHING APPARATUS FOR AUTOMOTIVE INTERIOR TRIM PRODUCTS AND METHOD FOR FORMING

(71) Applicant: HP-PELZER-PIMSA OTOMOTIV ANONIM SIRKETI, Kocaeli (TR)

(72) Inventors: Salim KARA, Kocaeli (TR); Cihangir Gökhan ABA, Kocaeli (TR)

(21) Appl. No.: 16/087,921

(22) PCT Filed: May 5, 2017
(86) PCT No.: PCT/TR2017/050174

§ 371 Date: Sep. 24, 2018

(30) Foreign Application Priority Data
Mar. 16, 2017 (TR) 2017/03972

(51) Int. Cl. B29C 55/04; B29C 55/20

(52) U.S. Cl. CPC B29C 55/04; B29L 2031/3017; B29C 55/20

(57) ABSTRACT

Stretching apparatus for automotive interior trim products and a method for forming The invention is a stretching apparatus which enables automotive interior trim products by being lifted between a lower mould and an upper mould before press, and a method for forming automotive interior trim products with this stretching apparatus.

### TECHNICAL FIELD

The invention relates to a stretching apparatus which enables automotive interior trim products by being lifted between a lower mould and an upper mould before press, and a method for forming automotive interior trim products with this stretching apparatus.

### PRIOR ART

In vehicles such as construction vehicles and cars (automobile), tractors, busses and trucks, interior trim products are used for preventing sound from getting inside the cabin. For instance, products such as vehicle floor carpets or vehicle front bonnet engine protectors have this function. The said products are produced by being pressed in moulds in proper forms.

In the state of the art, the carpet has to be lifted and fitted onto nails to be fixed into the forming mould. This application constitutes a problem both for ergonomics and occupational safety. In cases where the operator cannot fix the carpet fully, the carpet slips into the mould and causes to produce wastage carpet.

In order to solve the abovementioned problems, there are different nailing structures. For example, TR2016/13552 discloses an apparatus for holding and stretching fabric on the mould. The invention is a an apparatus for holding and stretching fabric, including needles which stretch the fabric from the moment when pressing procedure starts by moving in and out on the mould with its spring structure, and a spring head which houses these needles by covering thereof and enables them to appear by getting uncovered only during press and helps the fabric to get away from the needles at the end of press. However, the said apparatus does not remove human factors completely and the fabric is fitted to needles and the stretching is performed by humans. This again constitutes a problem for occupational safety. And it is always a possibility that the fabric easily dislocates and dodges inside the mould as the needles have springs.

Consequently the abovementioned problems make urges a need for bringing a novelty for the related field.

### BRIEF DESCRIPTION OF THE INVENTION

The present invention relates to an apparatus and forming method for automotive interior trim products in order to remove the abovementioned disadvantages and bring new advantages to the related field.

The main objective of the invention provide a stretching apparatus and forming method which enables to lift the interior trim products between a lower mould and an upper mould ergonomically and easily before press, and performs its function mechanically, electronically and pneumatically.

Another objective of the invention is to provide a stretching apparatus and forming method which decreases the rate of wastage in the production of automotive interior trim.

A further objective of the invention is to provide a stretching apparatus and a forming method which is safer and will decrease the risks of occupational safety and by less labor for automotive interior trim products.

In order to fulfill the all the abovementioned objectives and the detailed description below, the present invention is a stretching apparatus which enables to stretch automotive interior trim products between a lower mould and an upper mould by being lifted before press. The said stretching apparatus includes a holding jaw which enables to hold the said products prevented from dodge back, a driving and locking system which enables the said holding jaw to open and close and to keep it locked when closed, and a stretching system which enables to stretch the automotive interior trim product by lifting the said holding jaw and the driving and locking system backwards.

In order to fulfill the all the abovementioned objectives and the detailed description below, the present invention is a forming method which enables to form the automotive interior trim products between a lower mould and an upper mould. The said method includes the following process steps:
a) placing the raw material between the holding jaw,
b) holding the raw material by holding jaws and stretching the material by backward movement of the holding jaws,
c) detecting the completion of stretching process by a sensor automatically and giving approval,
d) performing the forming process by closing the upper mould after the approval of the process,
e) opening the press after forming and bringing the holding jaws into the starting position.

All the characteristics and advantages of the invention can be understood clearly by the figures and the references given to these figures below and assessment should be done by considering the descriptions and figures.

### BRIEF DESCRIPTION OF THE FIGURES

FIG. 1 is the isometric view of the inventive stretching apparatus when the jaws are in open position.

FIG. 2 is the isometric view of the inventive stretching apparatus when the jaws are in closed position.

### REFERENCE NUMBERS GIVEN IN FIGURES

1a. Upper holding jaw
1b. Lower holding jaw
2. Driving and Locking System
3. System body
4. Fixing plate
5. Hinge
6. Moving stretching system plate
7. Centering shaft bearing
8. Centering shaft
9. Stretching system carrier spring and shaft
10. Holding jaw piston
11. Stretching system
12. Control sensor

### DETAILED DESCRIPTION OF THE INVENTION

In this detailed description, the invention a stretching apparatus which enables automotive interior trim products by being lifted between a lower mould and an upper mould before press, and a method for forming automotive interior trim products with this stretching apparatus. Preferred embodiments of the materials used in the invention are described without any limiting effects on the understanding of the subject.

The inventive stretching apparatus which enables automotive interior trim products by being lifted between a lower mould and an upper mould before press includes:
a holding jaw (1a, 1b) which enables to hold the said materials at least preventing them from dodging back,
a driving and locking system (2) which enables the said holding jaw (1a, 1b) to open and close and to keep locked when it is closed,
a stretching system which enables to stretch the automotive interior trim product by lifting the said holding jaw (1a, 1b) and the driving and locking system (2) backwards.

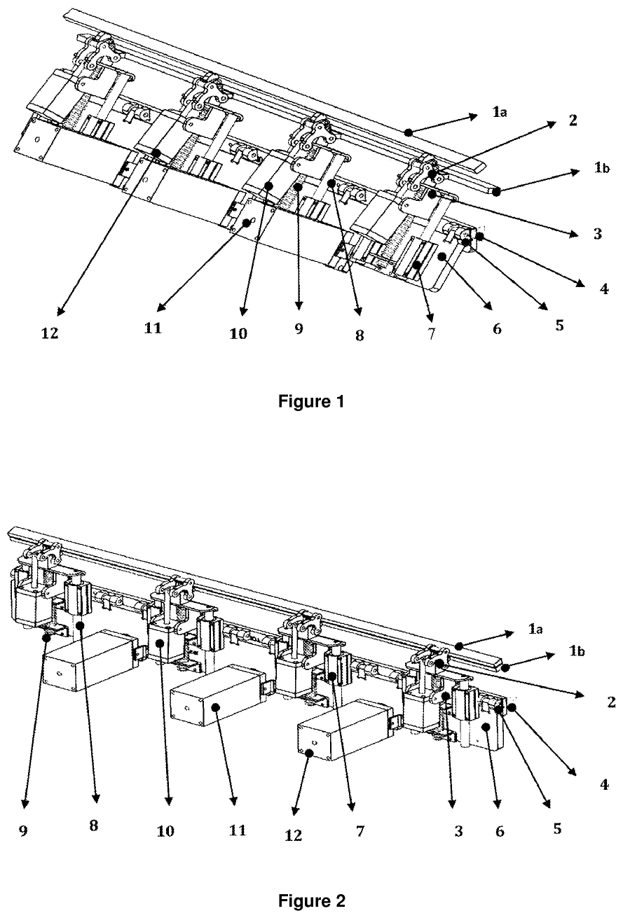

FIG. 1 shows a general view of the inventive stretching apparatus. The stretching apparatus is mounted in the forming mould. The stretching apparatus includes a fixing plate (4) connected to the forming mould. The said fixing plate (4) has a long profile structure. The length of the fixing plate (4) proceeds along the mould. The fixing plate (4) has connected holding jaws (1a, 1b) to perform stretching. Holding jaws (1a, 1b) proceed along the system body (3) and along the raw material in a way to hold the automotive interior trim product (raw material) at full length. There are two holding jaws (1a, 1b) as lower jaw (1b) and upper jaw (1a). Jaws (1a, 1b) have a structure that can be opened and closed. When jaws (1a, 1b) close, the lower jaw (1b) and the upper jaw (1a) close completely and enable to hold the material tightly.

To open and close the holding jaws (1a, 1b), there is a drive and locking system (2) connected to the lower jaw (1b) and upper jaw (1a). Driving and locking system (2) enables to open and close the jaws (1a, 1b) by the drive taken by the jaws (1a, 1b). Driving and locking system (2) may be plural, preferably five or six in number along the holding jaws (1a, 1b). Mentioned number can be less or much depends on the length and material structure of the mould. The said driving and locking system (2) may be composed of one or more of the pneumatic, electronic, hydraulic and mechanical systems. Besides, when the jaws (1a, 1b) close, the system (2) is enabled to lock itself and the lower jaw (1b) and upper jaw (1a) to hold the material tightly. There is a holding jaw piston (10) which gives drive to the holding jaws (1a, 1b) to open and close. The said holding jaw piston (10) is connected to the driving and locking system (2) by a system body (3). The number of the holding jaw piston (10) is the same as the driving and locking system (2).

After this raw material is held by the holding jaws (1a, 1b) this raw material is lifted. Lifting of the material is performed by lifting the driving and locking system (2) backwards with the holding jaws (1a, 1b) in an angular way. There is a centering shaft (8) connected to the system body (3) to which the driving and locking system (2) is connected, and a centering shaft bearing (7) in which the centering shaft (8) moves.

Centering shaft bearing (7) is connected to the moving stretching system plate (6). Stretching system plate (6), preferably proceeds along the mould and the fixing plate (4). Stretching system plate (6) has a rectangular profile structure. Stretching system plate (6) is connected to the fixing plate (4) with a hinge (5). The hinge (5) enables the movement of the stretching system plate (6). There is a control sensor (12) which signals whether the holding jaws (1a, 1b) are in or out of the mould. The control sensor (12) is on the stretching system (11). After the sensor (12) approves that the jaws (1a, 1b) are out of the mould, it is understood that the stretching procedure is completed. After the sensor (12) approval, forming process continues.

There is a stretching system (11) providing motion to the stretching system plate (6). The stretching system (11) provides the stretching force. When force is applied to the stretching system plate (6) by the stretching system (11), the stretching spring and shaft (9) and the stretching system plate (6) are kept upwards and thus the jaws (1a, 1b) are enabled to keep strained. Piston is preferably used as the stretching system (11).

The inventive forming method which enables to form the automotive interior trim products between a lower and an upper mould includes the process steps of;
a) placing the raw material between the holding jaws (1a, 1b),
b) holding the raw material between the holding jaws (1a, 1b) and stretching the raw material by the backward movement of the holding jaws (1a, 1b),
c) detecting the completion of the stretching process by a sensor (12) automatically and giving approval,
d) closing the upper mould after process approval and performing the forming process,
e) opening the press after forming and bringing the holding jaws (1a, 1b) to the starting position.

The embodiment of the invention is as follows in the light of the abovementioned details: Firstly, the heated raw material is placed into the mould. Afterwards, the inventive stretching apparatus holds the raw material by means of holding jaws (1a, 1b). While the raw material is held, the lower jaw (1b) and upper jaw (1a) holds the material by closing with the driving and locking system (2). After the holding process, the stretching system plate (6) will be driven by the stretching system (11) and lift the holding jaws (1a, 1b) backwards in an angular way. Thus, the material will be stretched. After the stretching process is completed, the control sensor (12) on the stretching system will signal that the stretching process is completed. Then, the upper mould will start to lower by the press. The fixed and stretched material will move downwards in the shaft bearing (7) by means of the centering shaft (8) by which it is connected to the system body (3). At the same time, carrier spring and the shaft (9) will be tightened by the stretching system. The raw material will be formed between the lower mould and the upper mould when the upper mould and the lower mould are closed. After the raw material is formed, the upper mould will elevate. When the process is completed and the upper jaw is opened, the tightened spring and shaft (9) will push the system upwards and bring it to the starting position. Finally, the driving and locking system (2) and the holding jaws (1a, 1b) will be released and the raw material will be taken from the mould.

Consequently, by the inventive method, risks such as work accident during forming process will be minimized. Amount of wastage will be decreased by preventing dodging during stretching and pressing. Forming process will be performed in an ergonomic and easy way. Accordingly, labor expenses will be reduced.

1. A stretching apparatus which enables to stretch automotive interior trim products between a lower mould and an upper mould by being lifted before press, characterized in that it comprises:
a holding jaw which enables to hold the said materials at least preventing them from dodging back;
a driving and locking system which enables the said holding jaw to open and close and to keep locked when it is closed;
a stretching system which enables to stretch the automotive interior trim product by lifting the said holding jaw and the driving and locking system backwards.

2. A stretching apparatus according to claim 1, characterized in that it comprises a fixing plate which enables the connection of the stretching apparatus to the forming mould.

3. A stretching apparatus according to claim 1, characterized in that it comprises a jaw piston which drives the holding jaws to open and close.

4. A stretching apparatus according to claim 3, characterized in that it comprises a system body which enables connection of the jaw piston with the driving and locking system.

5. A stretching apparatus according to claim 1, characterized in that it comprises a control sensor which signals whether the stretching process is completed depending on the holding jaws being in or out of the mould.

6. A stretching apparatus according to claim 1, characterized in that it comprises a stretching system carrier spring and shaft which gets tightened while the holding jaws are stretching the raw material and then enables to bring the jaws to the starting position after the forming process is completed.

7. A stretching apparatus according to claim 1, characterized in that it comprises a centering shaft which enables the downward movement of the system body while the upper mould is closing downwards.

8. A stretching apparatus according to claim 7, characterized in that it comprises a shaft bearing in which the centering shaft moves.

9. A stretching apparatus according to claim 1, characterized in that it comprises a moving stretching system plate which is driven by the stretching system to lift the holding jaws and driving and locking system backwards and is connected to the system body by the centering shaft.

10. A stretching apparatus according to claim 1, characterized in that the said driving and locking system is composed of one or more of the pneumatic, electronic, hydraulic and mechanical systems.

11. A stretching apparatus according to claim 1, characterized in that the said stretching system is preferably a piston.

12. A forming method which enables to form automotive interior trim products between a lower mould and an upper mould, characterized in that it comprises the steps of:
a) placing raw material between holding jaws;
holding the raw material between the holding jaws and stretching the raw material by the backward movement of the holding jaws;
detecting the completion of the stretching process by a sensor automatically and giving approval;
d) closing the upper mould after process approval and performing the forming process;
e) opening the press after forming and bringing the holding jaws to the starting position.

13. A forming method according to claim 12, characterized in that the said step “b” includes the step of closing the holding jaws by pressing with a pneumatic piston.

14. A forming method according to claim 12, characterized in that the said step “b” also includes the step of lifting the holding jaws backwards by pressing with a stretching system.

15. A forming method according to claim 12, characterized in that the said step “e” includes the step bringing the holding jaws to the starting position by a stretching system carrier spring and shaft.
